(19) United States
(12) Patent Application Publication
(10) Pub. No.: US 2022/0389243 A1
(43) Pub. Date: Dec. 8, 2022

(54) PAINT REMOVER COMPOSITION AND METHOD OF MAKING

(71) Applicant: W.M. Barr & Company, Inc., Memphis, TN (US)

(72) Inventors: Jonathan P. BREON, Memphis, TN (US); Timothy G. TEAGUE, Nesbit, MS (US); Dennis Earl SHIREMAN, Marion, AR (US)

(21) Appl. No.: 17/830,771

(22) Filed: Jun. 2, 2022

Related U.S. Application Data
(60) Provisional application No. 63/197,019, filed on Jun. 4, 2021.

(51) Int. Cl. C09D 9/00

(52) U.S. Cl. CPC C09D 9/005

(57) ABSTRACT

A paint remover composition and methods of making and using are provided. The composition has a primary ether or acetyl solvent with a molar volume of <100 cm³/mol, and an amine with a molar volume of <100 cm³/mol.

### CROSS-REFERENCE TO RELATED APPLICATIONS

This application claims priority from U.S. provisional patent application No. 63/197,019, filed on Jun. 4, 2021, in the United States Patent and Trademark Office. The disclosure of which is incorporated herein by reference in its entirety.

### FIELD OF THE INVENTION

The present invention generally relates to paint removers.

### BACKGROUND OF THE INVENTION

Most consumers use paint removers, also commonly referred to as paint strippers, for refinishing antique furniture, or woodworking's (doors, frames, moldings, etc.) in older houses. Many of these items have been painted, and repainted many times over the years. This results in items having multiple layers of paint containing different chemistry types and a different degree of difficulty from being removed. Paint removers are also used in the auto body repair industry to help with vehicle restoration.

Currently methylene chloride and N-Methylpyrrolidone (NMP) are used in the majority of paint removers in the United States. Methylene chloride has been the preferred solvent for use in paint removers for seventy years. Before methylene chloride was introduced, most paint removers consisted of volatile flammable solvents. Paint removers formulated with volatile solvents are extremely flammable and the flammability of these paint removers resulted in fires causing injury and deaths. These paint removers were rapidly replaced with the methylene chloride paint removers because methylene chloride paint removers can be formulated to be non-flammable and are effective in removing multiple layers of paint. The physical characteristics give the methylene chloride molecule the ability to quickly penetrate multiple layers and to soften or dissolve chemically resistant coatings. Methylene chloride does not deplete the ozone layer and is considered to make negligible contributions to smog formation, the green-house effect and acid rain. Like other organic solvents, methylene chloride can be harmful to human health if used improperly.

However, regulations are changing to remove methylene chloride and NMP from the environment. For example, the US Environmental Protection Agency (EPA) is considering a range of possible voluntary and regulatory actions to address risks from the use of methylene chloride-containing paint and coating removal products.

According to the EPA, NMP is both produced and imported into the United States, with use estimated at over 184 million pounds per year. EPA estimates that approximately 9 percent of total NMP usage is for paint and coating removal products.

On Jan. 12, 2017, EPA issued a proposed rule under section 6 of the Toxic Substances Control Act with two proposed approaches for regulating NMP. According to the EPA, one approach is to prohibit the manufacture (including import), processing, and distribution in commerce of NMP for consumer and commercial paint and coating removal; to prohibit commercial use of NMP; and to require manufacturers, processors, and distributors, except for retailers, of NMP to provide downstream notification of these prohibitions throughout the supply chain; and to require limited recordkeeping. According to the EPA, the second approach is a combination of requirements to address unreasonable risks to workers and consumers including to limit the amount of NMP in paint removal products to no more than 35 percent by weight; require formulators to evaluate and identify specialized gloves that protect against skin absorption; require occupational users to have worker protection programs to require that workers wear personal protective equipment to prevent skin and inhalation exposures, require hazard communication for commercial users; and require warning labels for consumers with detailed information on proper ways to reduce exposure.

Thus, there is a need for an alternative paint remover that is effective.

### SUMMARY OF THE INVENTION

The present invention generally relates to a paint remover composition, a method of making, and a method of using. The paint remover composition of the present invention is formulated without methylene chloride and N-Methylpyrrolidone (NMP).

In an embodiment of the invention, a composition is provided. The composition comprises a primary ether or acetyl solvent with a molar volume of <100 cm³/mol and an amine with a molar volume of <100 cm³/mol.

In an embodiment of the invention, a method of using is provided. The method comprises removing paint from an article with a composition, wherein the composition comprises a primary ether or acetyl solvent with a molar volume of <100 cm³/mol, and an amine with a molar volume of <100 cm³/mol.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### DESCRIPTION OF THE PREFERRED EMBODIMENTS

The following description of the embodiments of the present invention is merely exemplary in nature and is in no way intended to limit the invention, its application, or uses. The present invention has broad potential application and utility. The following description is provided herein solely by way of example for purposes of providing an enabling disclosure of the invention, but does not limit the scope or substance of the invention.

Further, the term “or” as used in this disclosure and the appended claims is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in,” “at,” and/or “on,” unless the context clearly indicates otherwise. The phrase “in one embodiment,” as used herein does not necessarily refer to the same embodiment, although it may.

In an embodiment of the invention, a composition for paint removal is provided. The paint remover composition generally comprises: a primary ether or acetyl solvent with a molar volume of <100 cm³/mol, and an amine with a molar volume of <100 cm³/mol.

The primary ether or acetyl solvent with the molar volume of <100 cm³/mol is present in an amount of 50 weight % to 90 weight %, wherein the weight is based on the weight of the composition.

The amine with the molar volume of <100 cm³/mol is present in an amount of 1 weight % to 10 weight %, wherein the weight is based on the weight of the composition.

The composition may further comprise water. The water is optionally present in an amount up to 20 weight %, wherein the weight is based on the weight of the composition.

The composition may comprise a water miscible solvent. The water miscible solvent is selected from the group consisting of an alcohol, a glycol, a glycol ether, and a combination thereof. The water miscible solvent is optionally present in an amount up to 20 weight %, wherein the weight is based on the weight of the composition.

The composition may comprise an aliphatic, cycloaliphatic, aromatic, or hydrocarbon solvent. The aliphatic, cycloaliphatic, aromatic, or hydrocarbon solvent is optionally present in an amount up to 10 weight %, wherein the weight is based on the weight of the composition.

The primary ether or acetyl solvent with a molar volume of <100 cm³/mol is selected from the group consisting of 1,3-dioxolane, dimethoxymethane, tetrahydrofuran, and a combination thereof.

The amine with a molar volume of <100 cm³/mol is selected from the group consisting of ammonia, hydroxylamine, dimethylamine, ethanolamine, pyrrolidine, and a combination thereof. The molar volume of the amine may be <30 cm³/mol.

The composition may comprise a cosolvent selected from the group consisting of methanol, ethanol, and a combination thereof.

Other components may be present in the composition for paint removal. The composition may comprise a solvent evaporation retarder such as a paraffin wax. Non-limiting examples of other components include, but are not limited to, dye, antioxidant, surfactant, thickener, fumed silica, corrosion inhibitor, ammonia, peroxide inhibitor (including but not limited to butylated hydroxytoluene), or a combination thereof. A non-limiting example of a thickener is a cellulosic thickener. The cellulosic thickener may be selected from the group consisting of hydroxypropyl methyl cellulose, hydroxypropyl cellulose, and a combination thereof. Non-limiting examples of corrosion inhibitors are amine containing corrosion inhibitors.

Amine containing corrosion inhibitors include, but are not limited to, primary, secondary, tertiary or quaternary amines, aliphatic, cycloaliphatic or aromatic amines, polyamines, amine salts, such as amine-mineral acid salts, amine-nitrites, amine-carboxylates, amine-phosphates, amine-borates, alkanolamines or alkanolamine-borate complexes, amine-metal complexes, amine containing heterocycles, azoles, and mixtures thereof.

Other components, alone or in combination, may be added in a range of 0 weight % to 25 weight %, more preferably 0.01 weight % to 12.5 weight %.

A solvent is a single solvent or a combination of solvents. Preferably, the solvent is selected from the group consisting of aromatic, aliphatic, cycloaliphatic, hydrocarbon, alcohol, glycol ether—benzene, xylene, toluene, dimethyl benzene, ethylbenzene, aliphatic hydrocarbon with 5 carbon or more, cycloaliphatic hydrocarbon with 5 carbon or more, methanol, ethanol, n-propanol, i-propanol, n-butanol, i-butanol, s-butanol, amyl alcohol, ethyleneglycol monomethylether, ethyleneglycol monoethylether, ethyleneglycol monopropylether, ethyleneglycol monobutyl ether, ethyleneglycol monohexylether, phenoxyethanol, propylene glycol monomethyl ether, propylene glycol monoethyl ether, propylene glycol monopropyl ether, propylene glycol monobutylether, propyleneglycol phenyl ether, diethyleneglycol monomethylether, diethyleneglycol monoethylether, diethyleneglycol monopropylether, diethyleneglycol monobutylether, diethyleneglycol monohexylether, diethyleneglycol phenylether, dipropyleneglycol monomethyl ether, dipropyleneglycol monoethyl ether, dipropyleneglycol monopropyl ether, dipropyleneglycol monobutyl ether, dipropyleneglycol phenyl ether, dipropyleneglycol dimethylether, tripropyleneglycol monomethyl ether, tripropyleneglycol monobutylether, ethylene glycol, propylene glycol, glycerol, propanediol, butanediol, 2-methylpropanediol, 1,2-pentanediol, 1,2-hexanediol, 2-methyl-2,4-pentanediol, caprylyl glycol, ethylhexyl glycerine, and a combination thereof.

In an embodiment of the invention, a method of using is provided. The method comprises removing paint from an article with a composition, wherein the composition comprises a primary ether or acetyl solvent with a molar volume of <100 cm³/mol, and an amine with a molar volume of <100 cm³/mol. The composition may be used to remove paint from various articles including, but not limited to, automobile, aircraft, among others.

### EXAMPLES

### Example 1

Paint stripping tests were conducted with formulations in accordance with the present invention.

TABLE 1
Comparison of Molar Volume of Primary Solvents

| | Mw | Density | Molar Vol. |
|---|---|---|---|
| Ingredient | (g/mol) | (g/cm³) | (cm³/mol) |
| 1,3-Dioxolane | 74.1 | 1.06 | 69.9 |
| Tetrahydrofuran | 72.1 | 0.888 | 81.23 |
| Dimethoxymethane | 76.1 | 0.859 | 88.6 |
| 2-Methyltetrahydrofuran | 86.1 | 0.854 | 100.8 |
| Acetonitrile | 41.05 | 0.786 | 52.2 |
| Methanol | 32.04 | 0.792 | 40.45 |

TABLE 2
Miscibility Test of Primary Solvent
with Aqua Ammonia (15 g. total)

| Primary | Cosolvent | | |
|---|---|---|---|
| Solvent | Solvent | NH₄OH* | Appearance |
| 85% Tetrahydrofuran | — | 15% | Phase separation |
| 78.5% Tetrahydrofuran | 6.5% Methanol | 15% | Miscible - clear |
| 78.5% Tetrahydrofuran | 6.5% DMSO | 15% | Phase separation |
| 72% Tetrahydrofuran | 13% DMSO | 15% | Phase separation |
| 85% 1,3-Dioxolane | — | 15% | Miscible - clear |
| 85% Dimethoxymethane | — | 15% | Miscible - clear |

*30% NH₄OH in water

TABLE 3
Evaluation of Primary Solvents in Paint Remover*

| Ingredient (wt. %) | Ex. 1 | Ex. 2 | Ex. 3 | Ex. 4 | Ex. 5 | Ex. 6 |
|---|---|---|---|---|---|---|
| Tetrahydrofuran | 71.5 | | | | | |
| 1,3-Dioxolane | | 85.4 | | | | 94.1 |
| Dimethoxymethane | | | 69.2 | | | |
| 2-Methyltetrahydrofuran | | | | 72.3 | | |
| Acetonitrile | | | | | 63.3 | |
| Xylene | 5 | 5 | 5 | 5 | 5 | 5 |
| Tylose PSO810001 | 1.5 | 1.5 | 1.5 | 1.5 | 1.5 | 1.5 |
| Parafin wax | 0.5 | 0.5 | 0.5 | 0.5 | 0.5 | 0.5 |
| Methanol | 6.5 | 6.5 | 6.5 | 6.5 | 6.5 | |
| 30% Ammonia in H₂O | 15 | 15 | 15 | 15 | 15 | 15 |

TABLE 4
Stripping Performance of Primary Solvents in Paint Remover

| | | Time to | |
|---|---|---|---|
| | | strip 2014 | |
| | | Chevy | |
| | | Cruise | Paint |
| | | hood | Layers |
| Example | Primary Solvent | (min) | Removed |
| Ex. 1 | Tetrahydrofuran | 98 | All |
| Ex. 2 | 1,3-Dioxolane | 117 | All |
| Ex. 3 | Dimethoxymethane | 152 | All |
| Ex. 4 | 2-Methyltetrahydrofuran | 285 | Clearcoat |
| | | | Basecoat |
| | | | Some primer |
| Ex. 5 | Acetonitrile | >360 | N/A |
| Ex. 6 | 1,3-Dioxolane | 105 | All |

TABLE 5
Evaluation of Amines in Paint Remover

| Ingredient (wt. %) | Ex. 7 | Ex. 8 | Ex. 9 | Ex. 10 | Ex. 11 | Ex. 12 | Ex. 13 |
|---|---|---|---|---|---|---|---|
| Tetrahydrofuran | 93.75 | 67.5 | 81.75 | 72.5 | 87.75 | 87.75 | 87.75 |
| Calumet LVP 100 | 5 | 5 | 5 | 5 | 5 | 5 | 5 |
| Tylose PSO810001 | 0.75 | 0.75 | 0.75 | 0.75 | 0.75 | 0.75 | 0.75 |
| Parafin wax | 0.5 | 0.5 | 0.5 | 0.5 | 0.5 | 0.5 | 0.5 |
| Methanol | | 6.25 | | 6.25 | | | |
| 30% Ammonia in H₂O | | 20 | | | | | |
| 50% Hydroxylamine in H₂O | | | 12 | | | | |
| 40% Dimethylamine in H₂O | | | | 15 | | | |
| Pyrrolidine | | | | | 6 | | |
| Ethanolamine | | | | | | 6 | |
| Dimethylethanolamine | | | | | | | 6 |

TABLE 6
Stripping Performance of Amines in Paint Remover vs. Molar Volume

| | | | | | Time to | |
|---|---|---|---|---|---|---|
| | | | | | Strip | |
| | | | | | 2004 | |
| | | | | Molar | Impala | Paint |
| | | Mw | Density | Vol. | trunk | Layers |
| Example | Amine | (g/mol) | (g/cm³) | (cm³/mol) | (min) | Removed |
| Ex. 7 | None | | | | 44 | Clearcoat |
| Ex. 8 | Ammonia | 17.03 | 0.73 | 23.3 | 10 | All |
| Ex. 9 | Hydroxylamine | 33.03 | 1.21 | 27.3 | 11 | All |
| Ex. 10 | Dimethylamine | 45.08 | 0.67 | 67.3 | 15 | All |
| Ex. 11 | Pyrrolidine | 71.12 | 0.87 | 89 | 22 | Clearcoat |
| | | | | | | Basecoat |
| | | | | | | Some primer |
| Ex. 12 | Ethanolamine | 61.08 | 1.01 | 60.5 | 21 | Clearcoat |
| | | | | | | Basecoat |
| | | | | | | Some primer |
| Ex. 13 | Dimethylethanolamine | 89.14 | 0.89 | 100.2 | 32 | Clearcoat |

TABLE 7
Evaluation of Increased Amine Level in Paint Remover

| Ingredient (wt. %) | Ex. 14 | Ex. 15 | Ex. 16 | Ex. 17 | Ex. 18 |
|---|---|---|---|---|---|
| Tetrahydrofuran | 93.75 | 77.5 | 67.5 | 57.5 | 81.75 |
| Calumet LVP 100 | 5 | 5 | 5 | 5 | 5 |
| Tylose PSO810001 | 0.75 | 0.75 | 0.75 | 0.75 | 0.75 |
| Parafin wax | 0.5 | 0.5 | 0.5 | 0.5 | 0.5 |
| Methanol | | 6.25 | 6.25 | 6.25 | |
| 30% Ammonia in H₂O | | 10 | 20 | 30 | |
| 50% Hydroxylamine | | | | | 12 |
| in H₂O | | | | | |

TABLE 8
Stripping Performance of Formulas with Increased Amine Level

| | Ex. 14 | Ex. 15 | Ex. 16 | Ex. 17 | Ex. 18 |
|---|---|---|---|---|---|
| Time to strip | >180 | 140 | 150 | >180 | >180 |
| 2014 Cruise | | | | | |
| hood (min) | | | | | |
| Paint Layers | Clearcoat | Clearcoat | All | All | Clearcoat |
| stripped | Basecoat | Basecoat | | | Basecoat |
| | | some primer | | | some primer |
| Time to strip | >180 | 32 | 30 | 40 | 45 |
| 2013 Impala | | | | | |
| trunk | | | | | |
| Paint Layers | Clearcoat | All | All | All | All |
| stripped | | | | | |

TABLE 9
Evaluation of Increased Cosolvent Solvent Level in Paint Remover

| Ingredient (wt. %) | Ex. 19 | Ex. 20 | Ex. 21 |
|---|---|---|---|
| Tetrahydrofuran | 74 | 64 | 54 |
| Calumet LVP 100 | 5 | 5 | 5 |
| Tylose PSO810001 | 0.75 | 0.75 | 0.75 |
| Parafin wax | 0.5 | 0.5 | 0.5 |
| Methanol | 4.75 | 14.75 | 24.75 |
| 30% Ammonia in H₂O | 15 | 15 | 15 |

TABLE 10
Stripping Performance of Formulas with
Increased Cosolvent Solvent Level

| | Ex. 19 | Ex. 20 | Ex. 21 |
|---|---|---|---|
| Time to strip | 145 | 210 | >360 |
| 2014 Cruise | | | |
| hood (min) | | | |
| Paint Layers | All | All | Clearcoat |
| stripped | | | Basecoat |
| | | | Some primer |

### Example: In-can Corrosion Inhibitor Screening

A blend of THF-30% NH₄OH aq. solution-methanol (80%-15%-5% by weight) was prepared and partitioned into 40 gram aliquots in 2 oz. glass jars with PTFE lined lids. 1″×2″ inch tin-plated cold-rolled steel coupons were cut from a square metal quart can to simulate accelerated in-can corrosion. Various corrosion inhibitors and corrosion inhibitor combinations (1% by weight) were post added to the individual glass jars with solvent blend and thoroughly mixed. The metal coupons were submerged in the glass jars, sealed, and stored in a 50° C. oven, being monitored regularly for corrosion in both liquid and vapor phases.

TABLE 11
Evaluation of corrosion inhibitors in THF-30% NH₄OH
aq. —MeOH (80-15-5% by weight) at 50° C.

| Corrosion inhibitor | Corrosion | Corrosion | Corrosion | Corrosion |
|---|---|---|---|---|
| (1 weight %) | (4 days) | (8 days) | (12 days) | (26 days) |
| None | Rusting, | Rusting, | Severe rusting, | Very severe rusting, |
| | vapor phase | vapor phase | vapor phase | vapor phase |
| 1% Morpholine | None | Slight rusting, | Rusting, | Severe rusting, |
| | | vapor phase | vapor phase | vapor phase |
| 0.5% Morpholine + | Slight rusting, | Rusting, | Rusting, | Severe rusting, |
| 0.5% Oleic acid | vapor phase | vapor phase | vapor phase | vapor phase |
| 1% Alkanolamine-borate | None | None | None | None |
| 0.5% Alkanolamine-borate + | None | None | None | None |
| 0.5% Monoethanolamine | | | | |
| 0.5% alkanolamine-borate + | None | None | None | None |
| 0.5% Lubrizol 2062¹ | | | | |
| 1% Lubrizol 2062 | None | None | Slight rusting, | Slight rusting |
| | | | vapor phase | & de-tinning, |
| | | | | vapor phase |

¹Mixed alkyl/aryl phosphate ester commercially available from Lubrizol

As demonstrated in Table 11, examples of effective corrosion inhibitors were alkanolamine-borates, alkanolamine-borates combined with amines, phosphate esters, and alkanolamine-borates combined with phosphate esters.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A composition comprising:
a primary ether or acetyl solvent with a molar volume of <100 cm³/mol, and
an amine with a molar volume of <100 cm³/mol.

2. The composition according to claim 1, wherein the primary ether or acetyl solvent with the molar volume of <100 cm³/mol is present in an amount of 50 weight % to 90 weight %, wherein the weight is based on the weight of the composition.

3. The composition according to claim 1, wherein the amine with the molar volume of <100 cm³/mol amine is present in an amount of 1 weight % to 10 weight %, wherein the weight is based on the weight of the composition.

4. The composition according to claim 1, wherein the composition further comprises water.

5. The composition according to claim 4, wherein the water is present in an amount up to 20 weight %, wherein the weight is based on the weight of the composition.

6. The composition according to claim 1, wherein the composition further comprises a water miscible solvent.

7. The composition according to claim 6, wherein the water miscible solvent is selected from the group consisting of an alcohol, a glycol, a glycol ether, and a combination thereof.

8. The composition according to claim 6, wherein the water miscible solvent is present in an amount up to 20 weight %, wherein the weight is based on the weight of the composition.

9. The composition according to claim 1, wherein the composition further comprises an aliphatic, cycloaliphatic, aromatic, or hydrocarbon solvent.

10. The composition according to claim 9, wherein the aliphatic, cycloaliphatic, aromatic, or hydrocarbon solvent is present in an amount up to 10 weight %, wherein the weight is based on the weight of the composition.

11. The composition according to claim 1, wherein the primary ether or acetyl solvent with a molar volume of <100 cm³/mol is selected from the group consisting of 1,3-dioxolane, tetrahydrofuran, dimethoxymethane, and a combination thereof.

12. The composition according to claim 1, wherein the amine with a molar volume of <100 cm³/mol is selected from the group consisting of ammonia, hydroxylamine, dimethylamine, ethanolamine, pyrrolidine, and a combination thereof.

13. The composition according to claim 1, wherein the molar volume of the amine is <30 cm³/mol.

14. The composition according to claim 1, further comprising a cosolvent selected from the group consisting of methanol, ethanol, and a combination thereof.

15. The composition according to claim 1, further comprising a solvent evaporation retarder.

16. The composition according to claim 15, wherein the solvent evaporation retarder is a paraffin wax.

17. The composition according to claim 1, further comprising a cellulosic thickener.

18. The composition according to claim 17, wherein the cellulosic thickener is selected from the group consisting of hydroxypropyl methyl cellulose, hydroxypropyl cellulose, and a combination thereof.

19. The composition according to claim 1, further comprising a corrosion inhibitor.

20. The composition according to claim 19 wherein the corrosion inhibitor is selected from the group consisting of an alkanolamine-borate, alkanolamine-borate combined with amine, phosphate ester, alkanolamine-borate combined with phosphate ester, and a combination thereof.

21. The composition according to claim 1, wherein the composition is a paint remover.

22. A method of using comprising:
removing paint from an article with a composition, wherein the composition comprises a primary ether or acetyl solvent with a molar volume of <100 cm³/mol, and an amine with a molar volume of <100 cm³/mol.
